(19) United States
(12) Patent Application Publication
(10) Pub. No.: US 2004/0190622 A1
(43) Pub. Date: Sep. 30, 2004

(54) Motion estimation and compensation with controlled vector statistics

(76) Inventors: Robert Schutten, Campbell, CA (US); Abraham Riemens, Eindhoven (NL); Pieter Van Der Wolf, Eindhoven (NL)

Correspondence Address: Corporate Patent Counsel, Philips Electronics North America Corporation, PO Box 3001, Briarcliff Manor, NY, 10510, US

(21) Appl. No.: 10/482,149

(22) PCT Filed: Jun. 20, 2002
(86) PCT No.: PCT/IB02/02420

(30) Foreign Application Priority Data
Jul. 6, 2001 (EP) 01202611.8

(51) Int. Cl. H04N 7/12

(52) U.S. Cl. 375/240.16; 375/240.12

(57) ABSTRACT

Method and system for motion compensation in video image data, comprising a motion estimator (12) arranged for analysing motion in consecutive frames of the video image data and deriving a motion vector field in dependence on said motion, a motion compensator (14) connected to the motion estimator (12) and first storage means (15). The motion compensator (14) is arranged for performing motion compensation by storing a subset of the video image data in a first storage means (15) and, for each vector retrieving the required data from the first storage means (15), where in cases that the required data is not entirely available in the first storage means (15), video image data containing at least the missing parts of the required data, is retrieved from a second storage means (10) and stored in the first storage means (15).

The motion estimator (12) is further arranged to select motion vectors in the video motion vector field which meet at least one statistical property.

The present application relates to a method and system for motion estimation and compensation in video image data.

Known systems for motion estimation and compensation have significant bandwidth requirements for accessing video image data in an off-chip memory. In some systems, a cache is used to reduce the bandwidth requirements. Due to spatial locality in accesses to the video image data, the average behaviour may improve. However, no guarantee exists that such a spatial locality is present, and therefore, the worst case behaviour is not improved. Hence, a guaranteed reduction in bandwidth required for performing the accesses is not provided.

European patent application EP-A-0 294 957 describes a method and apparatus for motion vector processing in digital television images. This document describes a filter circuit for motion vectors in order to enhance the quality of the vectors in some specific situations. The filter circuit makes the motion estimator more robust for noise in the image and assures that the motion estimator circuit delivers more reliable zero vectors.

Various motion estimation techniques and an implementation are described by G. de Haan et al. in “True motion estimation with 3-D recursive block matching”, IEEE Trans. CSVT, Oct. 1993, pp.368-388 and “IC for motion-compensated de-interlacing, noise reduction, and picture-rate conversion”, IEEE Trans. on CE, Aug., 1999, pp. 617-624.

The present invention aims to provide a motion estimation and motion compensation method and system for processing video data, in which the use of memory bandwidth during motion compensation is limited to a certain maximum in all possible circumstances while applying a small motion compensation data cache.

According to the present invention, a method is provided for motion estimation and motion compensation in video image data, comprising the steps of a) analysing motion in consecutive images of video image data and deriving a motion vector field in dependence on said motion; b) performing motion compensation by storing a subset of the video image data in a first storage means and, for each vector retrieving the required data from the first storage means, where in cases that the required data is not available in the first storage means, video image data containing at least the missing parts of the required data, is fetched from a second storage means and stored in the first storage means; in which in step a) motion vectors in the video motion vector field are selected which meet at least one statistical property.

Many present systems, like the implementation described by de Haan, apply a cache or two dimensional buffer to store a subset of an image. The motion compensation fetches data from the cache while applying motion vectors. In typical systems, the cache or two dimensional buffer covers the whole search range of the motion vectors; usually it consists of line memories. This results in a relatively large amount of memory, e.g. 720 pixels wide and 24 lines (with an associated maximum vertical vector range of [−12 . . 12]). Such a cache thus requires at least 17,280 pixels of buffering. The present invention allows a motion compensation data cache of substantially smaller size. It would typically store only a few hundred pixels. Without special measures, the use of a small motion compensation cache would lead to potentially very high bandwidth demands between the image store and the cache. Especially in case of complex video scenes with a lot of motion in various directions, the refresh rate of the cache may cause excessive data traffic, potentially exceeding the available bandwidth. As a result, refreshing the cache may become too slow, which usually results in loss of an output image. This is considered to be a very severe artefact which shall be avoided. The present invention allows to use a small cache and at the same time guarantees a predetermined maximum bandwidth use, which is substantially lower than the worst case bandwidth use.

It is clear, that the efficiency of a data cache depends on the spatial locality of the data references. This locality is related to the size of the cache. For a large data cache, as applied in existing systems, all data accesses will fetch data from the buffer. For a small cache as proposed here, some data requests will access data that is available in the cache, other requests will access data that is not available. The latter causes a (partial) refresh of the data cache, and thus causes data transfer from the image store to the cache. Since the location in the image where the data is accessed depends on the motion vector, the cache efficiency depends on statistics of the vector field.

In certain applications using motion estimation and compensation, such as video scan rate conversion and time shift recording, the motion estimation is followed by motion compensation in a single system. In such situations, the motion estimator can be controlled in such a way, that the vector field it calculates complies to predetermined vector statistics. As a result, the bandwidth use between image store and motion compensation cache is guaranteed to be below a certain limit.

By using appropriate statistical properties of the video motion vector field, it is possible to guarantee that the use of a local buffer (or cache) as used by the motion compensator reduces the bandwidth required for accessing video image data in off-chip memory to a certain, guaranteed extent. This will avoid the possibility that, e.g. in a situation with a lot and complex motion in a scene, the bandwidth required potentially exceeds the available bandwidth, resulting in delay of the motion compensation process. The required statistical properties may be achieved by giving preference to candidate motion vectors that improve the spatial locality of the accesses to be performed by the motion compensator.

The at least one statistical property or constraint may be dependent on a first amount of bandwidth for accessing the second storage means. The first amount may be the amount available for the second storage means, i.e. limited by hardware characteristics. Alternatively, the first amount may be the amount of bandwidth available to the motion compensator.

Also, the at least one statistical property may be dependent on at least one architectural property of the memory system, i.e. the first storage means, second storage means and the communication means between first and second storage means (including supported data transfer types/protocols).

In a further embodiment, the at least one statistical property is dynamically adjusted, depending on an actually available bandwidth for accessing the second storage means. By dynamically controlling the statistical properties (e.g. determining the statistical property from time to time), the data traffic from the second storage means caused by the motion compensation may be influenced. The latter is particularly useful in systems with shared memory where also other functions access the second storage means.

In a further embodiment, the method comprises the further step of making available at least one actually used statistical property by the motion estimator to a further system using the first storage means. The actually used statistical property may be different from the at least one statistical property. Moreover, the at least one actually used statistical property may be used to determine the actually used bandwidth for accessing the second storage means, and the difference between available bandwidth and actually used bandwidth may be made available to a further system. E.g., the motion estimator may report the actually found statistics to further systems using the second storage means. From this information, other system components may determine the actual bandwidth requirements for the motion compensation. In case the motion compensation does not actually use all available bandwidth, other system components may be allowed to use that bandwidth.

In a further embodiment, step a) comprises the further steps of a1) determining a set of candidate motion vectors for a further subset of the image; a2) calculating at least one penalty value, depending on a correlation between a previously selected motion vector and each of the candidate motion vectors; a3) selecting a further motion vector from the set of candidate motion vectors while taking into account the at least one penalty value of the candidate motion vectors and statistics of the at least one penalty value of previously selected motion vectors and the at least one statistical property. The further subset of the image may be horizontally adjacent (left/right) or vertically adjacent (above/below) the subset of the image which has previously been processed in order to select a motion vector. When the correlation is below a predetermined threshold value, the vectors are weakly correlated, and it will be necessary to (partially) refresh the first data storage means during motion compensation. This will increase the bandwidth use to access the video image data in the second storage means. The penalty is calculated such, that it is a measure of the amount of bandwidth that will be required to access the second storage means during motion compensation. By taking into account the statistics of the penalty values that belong to the actually selected motion vectors in the current image when selecting a motion vector from the candidate motion vectors, the statistics of the penalty values including the penalty of the newly selected motion vector may be limited by the at least one statistical property that is input to the motion estimator. As an example, the sum of all penalty values may represent a certain amount of bandwidth for accessing the second storage means during motion compensation. In the method described here, this sum may be limited, thus limiting the bandwidth. In known motion estimation methods, selection is based on a match error of the candidate motion vectors and other characteristics of the candidate motion vectors, such as the origin of the candidate motion vector with respect to the current location.

In a further embodiment the statistics of the at least one penalty value of the previously selected motion vectors are based on all previously selected motion vectors, and thus take all motion vectors that have been selected in the current image into account. This way, the bandwidth to access the second storage means during motion compensation is limited at the granularity of single images. As a result, the average bandwidth use during motion compensation for the whole image is limited, but still high peak bandwidth consumption during processing of a part of the image is possible.

In some situations this is not acceptable or this leads to more costly implementations. Therefore, in a further embodiment, these statistics of the at least one penalty value of the previously selected motion vectors take only a subset of the motion vectors that have been selected in the current image into account. This way, the granularity of control is refined to a part of the image and the high peak bandwidth consumption during motion compensation of a part of the image can be avoided.

When using the earlier mentioned embodiment, the beginning of the image processing may be of a different quality than the end of the image processing, as the motion estimation steps may force motion vectors in the end part to be more strongly correlated than in the begin part to meet the at least one statistical property at the end of the image. This may cause a potentially visible artefact. This situation may be improved by using the fact that there usually is a strong temporal correlation between successive images in a video sequence. Via temporal feedback, the statistical properties of the image sequence may be used, thus obtaining a more uniform image quality. This may be accomplished in a further embodiment, in which the statistics of the at least one penalty value of selected motion vectors in previous images are used to further influence the selection process of step a3).

In an even further embodiment, the further subset of the image is chosen dependent on architectural properties of the memory and communication means, including the first storage means, second storage means or communication means. This allows to optimise the scanning order of video images to the architectural properties of the system.

In a further aspect, the present application is related to a system according to one of the claims 2 to 12. This system is arranged to accomplish the results of the present method in a simple and efficient implementation.

The system may be advantageously used in a television set or in a set top box.

The present invention will be explained in more detail below by describing a number of exemplary embodiments, with reference to the accompanying drawings, in which:

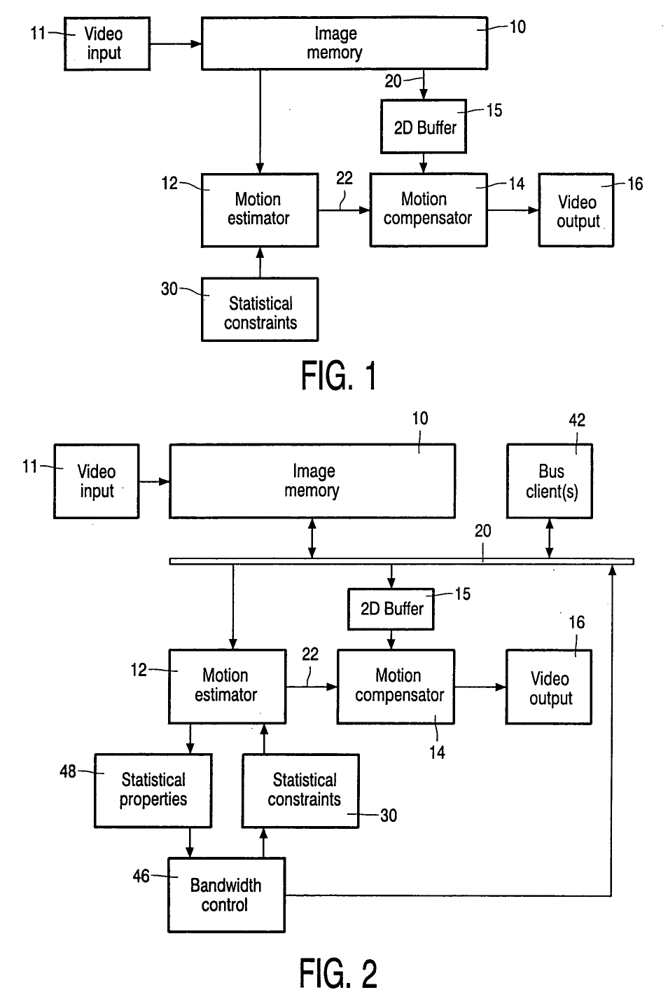

FIG. 1 shows a schematic diagram of a motion estimation/compensation system according to an embodiment of the present invention;

FIG. 2 shows a schematic diagram of a motion estimation/compensation system according to a further embodiment of the present invention;

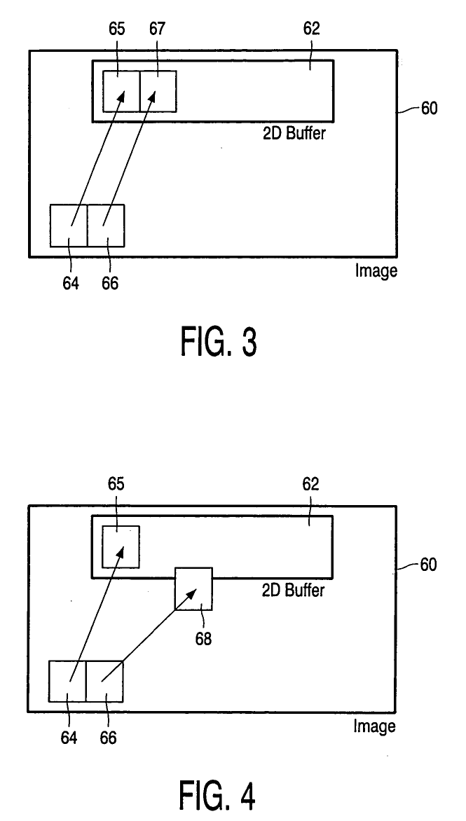

FIG. 3 shows schematically an image including a subset in the cache;

FIG. 4 shows schematically an image including a further subset in the cache.

Many applications for embedded systems in the video domain employ motion estimation and/or motion compensation techniques. A key aspect of such applications is that they have significant bandwidth requirements for accessing video data in (relatively large) image memory. One option is to use a cache for reducing these bandwidth requirements, resulting in an improved average case behaviour due to the spatial locality in the accesses to the video data. However, since such a spatial locality is not guaranteed, such a cache will not improve the worst case behaviour and will consequently not provide a guaranteed reduction in bandwidth required for performing these accesses.

In FIG. 1 a simplified block diagram is shown of a motion estimation and motion compensating system for use in video applications. The system comprises a motion estimator 12 and a motion compensator 14. Furthermore, the system comprises a two dimensional buffer 15 for storing a relatively small 2D area of a video image (e.g. 32 pixels by eight lines). The video image frame is input to the two dimensional buffer from an (possibly off chip) image memory 10, under control of the motion compensator 14 and/or two dimensional buffer 15. The image memory 10 may contain multiple video images. This image memory is filled with input video data 11. In motion estimation and motion compensation functions, blocks of video data are accessed via a motion vector. The buffer 15 is used to be able to reuse video data, thereby effectively reducing the bandwidth requirement of the connection 20 between image memory 10 and two dimensional buffer 15.

The motion estimator 12 is arranged to analyse consecutive video image fragments in the image memory 10 and derives motion vectors using well known motion estimation techniques. Various motion estimation techniques are described by G. de Haan et al. in ‘True motion estimation with 3-D recursive block matching’, IEEE Trans. CSVT, Oct. 1993, pp. 368-388.

Via communication means 22, the vectors are transferred to motion compensator 14, which uses the motion vectors to access video image data in the two dimensional buffer 15. In case the data is not present in the buffer, it will be (partially) refreshed with new data from the video image memory 10. After processing the video data from the buffer, the results of motion compensator 14 are transferred to video output data 16.

The architectural properties of the two dimensional buffer 15 are usually defined during the design of a specific implementation. This may also be true for the connection 20 between the image memory and the 2D buffer, providing a predetermined bandwidth for the motion compensation. However, situations may exist, in which the image memory is shared with other functions. Such a more advanced system is shown in FIG. 2.

Since the image memory in FIG. 2 is shared between multiple functions, the connection means 20 between the image store 10 and the buffer 15 is extended. In this case, it would typically be implemented as a communication bus 20. As an example, bus client 42 is added to the system; this bus client may perform a function that is either related or not related to the motion estimation and motion compensation. In a system like this, the bandwidth available to the motion compensator 14 on communication means 20 may vary significantly, depending on e.g. whether bus client 42 is active. The bandwidth use of the motion compensator 14 can be controlled by statistical constraints in the motion estimator 12. In this system, these statistical constraints 30 are dynamically adapted to the available bandwidth on the bus by a bandwidth control unit 46. As a further refinement of the system, the bandwidth control unit can also retrieve the actual statistical properties 48 from the motion estimator 12. By analysing this information, the bandwidth control unit 46 can predict the required bandwidth that the motion compensator 14 will actually use when the motion vectors are applied. In case that bandwidth is below the bandwidth limit enforced by the statistical constraints 30, this extra bandwidth may be used to improve the quality of other functions.

By varying the statistical constraints 30, a controlled trade off between image quality and bandwidth consumption is possible, thus providing graceful degradation of the quality of the output images of the motion compensator 14 when bandwidth limitation so requires.

By applying these mechanisms of bandwidth control on the system of FIG. 2, it is even possible to implement quality of service over multiple functions, as well as graceful degradation in case of bus overload, again optimised over multiple functions.

In digital video processing techniques, the motion estimation function determines a vector field for motion of blocks of image data. The vectors in normal video image sequences are highly correlated in a large percentage of the cases (assume 75%) and completely uncorrelated in a further percentage of the cases (assume 25% in a worst case situation). Also, a definition may be given of weakly and strongly correlated vectors. If a next vector is weakly correlated, then the required data is not (or not entirely) in the two dimensional buffer 15, and the buffer 15 needs to be (partially) refilled from the image memory 10. If, however, the next vector is strongly correlated, then the required data will be available in the buffer 15.

By means of example, FIG. 3 and 4 show how correlation of adjacent motion vectors is related to cache efficiency and thus data traffic between an image memory 10 and the buffer 15. FIG. 3 shows an image 60, where a subset 62 of the image data is available in the cache 15. It further shows two motion vectors that belong to two adjacent blocks of image data 64 and 66. The two motion vectors are strongly correlated, and, as a result of that, the two blocks 65, 67 that are accessed via the motion vectors reside both in the subset 62 of the image data that is in the cache. In FIG. 4, a similar situation is depicted, however, in this case the two motion vectors are weakly correlated. Because of the large difference between the vectors, the second block of image data 68 that is accessed via a motion vector does not reside within the subset 62 of image data that is in the cache. Consequently, the cache needs to be (partially) refreshed.

The bandwidth requirements of the communication means 20 between video image memory 10 and two dimensional buffer 15 may be reduced when the data in the two dimensional buffer 15 is reused as much as possible. In average case behaviour the efficiency of reuse of data may be enlarged due to the spatial locality of the accesses to the video data. However, in normal video data, no guarantee exists that such a locality is present, and the use of a two dimensional buffer does not improve the worst case behaviour, and hence does not provide a guaranteed reduction in bandwidth required for performing the accesses to the video image memory 10.

From the image data in the image memory 10, the motion estimator determines a motion vector field. During the calculation of the vector field, the motion estimator 12 assures that the statistical constraints 30 are met. Therefore, the motion estimator 12 may give preference to candidate motion vectors that improve the spatial locality of the accesses to be performed by the motion compensator 14. This will improve the hit rate of the two dimensional buffer 15 and thus reduce the bandwidth required for accessing the video image memory 10 by means of the communication means 20.

In the present invention, the percentage of weakly correlated vectors that may be selected by the motion estimator 12 is limited, in order to assure that a certain bandwidth limit is not exceeded. Whether a candidate motion vector for a certain image part is weakly or strongly correlated depends on the architecture of the two dimensional buffer 15 and the architecture of the communication means 20. Also, the buffer size is relevant. The statistical constraints 30 thus depend on the available bandwidth between image memory 10 and two dimensional buffer 15 and on architectural properties of the memory system.

In general, the motion estimation function as implemented by the motion estimator 12 comprises three steps. First a set of candidate motion vectors is determined for a given subset of an image. Next, a match criterion is calculated for each candidate vector and, finally, the best candidate motion vector is selected as output vector from the motion estimator 12. Each of the steps are repeated for every part of the image, resulting in a complete vector field for the specific image.

In the article of Haan et al. (see above), a particular effective method of motion estimation is three dimensional recursive search. In such a method only a very limited number of candidate vectors exist. Among these, there are a few candidate vectors which are identical to or derived from calculated vectors on neighbouring image parts. By definition, identical vectors are strongly correlated. Also, derived vectors may be strongly correlated in many cases. When building the motion vector field for an image, in this case, not only the matching criterion is used, but also, an additional criterion is taken into account (the correlation value of a candidate vector with a neighbouring vector). Therefore, the motion estimator first calculates a penalty value for each of the candidate motion vectors. These penalty values depend on the amount of correlation between the candidate motion vector and the neighbouring calculated motion vector. This penalty value is a measure for the amount of bandwidth required during motion compensation. When selecting the result motion vector from the candidate motion vectors, the calculated penalty values are analysed, while also taking the statistics of the penalty values of the previously selected motion vectors into account. So, apart from the regular match criterion, this analysis of the penalty values is an additional selection criterion. This way, a result motion vector which is strongly correlated may be selected, even if it does not have the best match, and thus the resulting motion vector is corrected in order to assure that the bandwidth during motion compensation is within certain limits. Such a correction may yield some decrease of image quality.

This process works conveniently under the assumption that strongly and weakly correlated vectors are uniformly distributed over the image, and thus that the corrections in the motion estimator are uniformly distributed over the image, since this implies that also the image quality is constant over the image. In some video sequences this may be different, and the described method may result in a different image quality at the beginning of the image processing as compared to the end of the image processing. This may be caused by the motion estimator 12 running into trouble at the end as it may have to force strongly correlated vectors to be able to achieve the required percentage of weakly correlated vectors.

In most video sequences, a strong temporal correlation exists between successive images in a video sequence. Via a temporal recursive feedback loop, the motion estimator 12 can estimate the required percentage or the total number of corrections for a specific image from the statistical properties of the sequence, and spread the preference for weakly or strongly correlated candidate motion vectors uniformly over the image, thus delivering an image with a constant quality level.

The neighbouring image parts (or motion vector) can be horizontally adjacent (left or right) or vertically adjacent (above or below). Which of the alternatives is chosen may be dependent on the architectural properties of the memory system, in order to optimise the scanning order.

When the statistical properties of the motion vector field are not used in a system with a small cache, a situation with a lot and complex motion in the scene will result in a lot of necessary accesses to the video image memory 10, resulting in an overload of the communication means 20. As a result, a possible effect may be, that the calculated image is not in time, effectively causing a missing image at the video output 16.

When the method and system according to the present invention are used in the same situation, the result may be a reduced quality of the vector field output by the motion estimator 12, since the constraints of the vector consistency will force the motion estimator 12 to select non-optimal vectors. This may result in a degraded image quality in the video output 16 after motion compensation by the motion compensator 14. However, the much more serious artefacts of missing images in the video stream will be prevented, as a result of which the perceived image quality will improve. Also, the reliability and predictiveness of the system behaviour will improve. Furthermore, quality of service in a system with multiple functions using shared resources is made possible.

1. Method for motion compensation in video image data, comprising the steps of
a) analysing motion in consecutive images of the video image data and deriving a motion vector field in dependence on said motion;
b) performing motion compensation by storing a subset of the video image data in a first storage means (15) and, for each vector retrieving the required data from the first storage means (15), where in cases that the required data is not entirely available in the first storage means (15), video image data containing at least the missing parts of the required data, is fetched from a second storage means (10) and stored in the first storage means (15);
in which in step a) motion vectors in the video motion vector field are selected which meet at least one statistical property.

2. System for motion compensation in video image data, comprising
a motion estimator (12) arranged for analysing motion in consecutive frames of the video image data and deriving a motion vector field in dependence on said motion;
a motion compensator (14) connected to the motion estimator (12) and first storage means (15), the motion compensator (14) being arranged for performing motion compensation by storing a subset of the video image data in a first storage means (15) and, for each vector retrieving the required data from the first storage means (15), where in cases that the required data is not entirely available in the first storage means (15), video image data containing at least the missing parts of the required data, is fetched from a second storage means (10) and stored in the first storage means (15);
the motion estimator (12) being further arranged to select motion vectors in the video motion vector field which meet at least one statistical property.

3. System according to claim 2, in which the at least one statistical property is dependent on a first amount of bandwidth for accessing the second storage means (10).

4. System according to claim 2, in which the at least one statistical property is dependent on at least one architectural property of the first storage means (15), the second storage means (10), or the communication means (20) between first and second storage means (10).

5. System according to claim 2, in which the at least one statistical property is dynamically adjusted, depending on an actually available bandwidth for accessing the second storage means (10).

6. System according to claim 2, in which the motion estimator (12) is arranged to make available at least one actually used statistical property to a further system (42).

7. System according to claim 6, in which the motion estimator (12) is arranged to use the at least one actually used statistical property to determine the actually used bandwidth for accessing the second storage means (10), and to make the difference between available bandwidth and actually used bandwidth available to the further system (42).

8. System according to claim 2, in which the motion estimator (12) is further arranged to determine a set of candidate motion vectors for a further subset of the image, to calculate at least one penalty value, depending on a correlation between a previously selected motion vector and each of the candidate motion vectors and to select a further motion vector from the set of candidate motion vectors while taking into account the at least one penalty value of the candidate motion vectors and statistics of the at least one penalty value of previously selected motion vectors and the at least one statistical property.

9. System according to claim 8, in which the statistics of the at least one penalty value of previously selected motion vectors are based on all previously selected motion vectors in the current image.

10. System according to claim 8, in which the statistics of the at least one penalty value of previously selected motion vectors are based on a subset of the previously selected motion vectors in the current image.

11. System according to claim 8, in which the statistics of the at least one penalty value of selected motion vectors in previous images are used to further influence the selection of the further motion vector.

12. System according to claim 8, in which the further subset of the image is chosen dependent on at least one architectural property of the first storage means (15), second storage means (10), or communication means (20).

13. Television set comprising a system for motion compensation according to claim 2.

14. Set top box comprising a system for motion compensation according to claim 2.
